(19) United States
(12) Patent Application Publication
(10) Pub. No.: US 2026/0280909 A1
(43) Pub. Date: Sep. 17, 2026

(54) OUTPUT PRIVATE DISTRIBUTED VRFS AND APPLICATION TO BLOCKCHAINS

(71) Applicant: Unity Chain, Inc., Miami, FL (US)

(72) Inventors: Aniket Pundlik KATE, West Lafayette, IN (US); Pratyay Mukherjee, Kolkata, (IN); Easwar Vivek Mangipudi, Mountain View, CA (US); Jacob Benjamin Matan Gorman, New York, NY (US)

(73) Assignee: Unity Chain, Inc., Miami, FL (US)

(21) Appl. No.: 19/166,296

(22) PCT Filed: Mar. 20, 2024
(86) PCT No.: PCT/US2024/020821

§ 371 Date: Sep. 17, 2025

Related U.S. Application Data
(60) Provisional application No. 63/453,722, filed on Mar. 21, 2023.

(51) Int. Cl. H04L 9/00

(52) U.S. Cl. CPC H04L 9/50

(57) ABSTRACT

This disclosure relates generally to a method of generating a blinded random output, including executing a randomness request by a requester; sharing fractions of a key with a committee to generate partial evaluations of a random output, the partial evaluations being blinded; aggregating the partial evaluations of the random output, the partial evaluations of the random output also being blinded; generating a blinded public output corresponding to the randomness request; and sending the blinded public output to the requester, such that the requester may obtain the private random output.

### CLAIM FOR PRIORITY

This application claims the benefit of and priority to U.S. Provisional Application No. 63/453,722, filed on Mar. 21, 2023, and titled, “OUTPUT PRIVATE DISTRIBUTED VRES AND APPLICATION TO BLOCKCHAINS,” the entire contents of which are herein incorporated by reference.

### TECHNICAL FIELD

This disclosure relates generally to the field of verifiable random function (VRF) protocols in blockchain environments. More specifically, this disclosure relates to the generation of output-private random values that can be used within blockchain environments.

### BACKGROUND

Randomness is a precious resource in computing. Its utility ranges from generating cryptographic keys to performing simulations to facilitating online gaming. With the significant rise of blockchain technology and Web3-based applications such as decentralized finance and GameFi, the demand for reliable sources of randomness has increased enormously. In many of these applications involving multiple parties, it is important to ensure that the employed randomness is not predictable to, or biased towards, any particular party. However, given that secure on-chain randomness generation within a smart contract is inefficient, if not infeasible, for most blockchains, a natural approach is to delegate this to off-chain computation. Off-chain computations, nevertheless, must be verified on-chain to ensure the integrity of computation. Verifiable random functions (VRFs) enable such functionality.

Web3 applications based on blockchains regularly require access to randomness that is unbiased, unpredictable, and publicly verifiable. A verifiable random function (VRF) protocol naturally satisfies these requirements, leading to a tremendous rise in the use of VRF services. Since most blockchains cannot maintain the secret-keys required for VRFs, Web3 applications interact with external VRF services via a smart contract, where a VRF output is exchanged for a fee. Smart contracts are digital contracts stored on a blockchain (typically an Ethereum blockchain, though any blockchain service can execute and store smart contracts) that are automatically executed when predetermined terms and conditions are met.

While this smart contract-based plain-text exchange offers the much-needed public verifiability immediately, it severely limits the way the requester can employ the VRF service: the requests cannot be made in advance, and the output cannot be reused. This introduces significant latency and monetary overhead.

A Verifiable Random Function, V, is a keyed deterministic function which, on an input tag or string x, outputs a string y=Vsk (x). The secret-key sk is selected uniformly at random. The VRF provides two security guarantees: (i) pseudo-randomness, which implies that, as long as the secret-key is hidden, the output is indistinguishable from a uniform random string; and (ii) verifiability, which implies that given x, y and a proof π, anyone can publicly verify that y is indeed computed correctly as Vsk (x)—such proof is produced using the secret-key sk. As a result, VRFs are sought after in blockchains, online gaming, and online lotteries. The use of a VRF allows the service providers to demonstrate that they are running their services unbiasedly.

In the blockchain industry, VRFs are typically offered as a service for a fee. That is, the VRF service and a randomness requester (e.g., a gaming platform), communicate through a smart contract (i.e., the automatically executing digital agreement). For example, as illustrated in FIG. 1, a requester 100 (or user) (e.g., a gaming platform, a gambling platform, a blockchain environment, etc.) makes a randomness request 102 to the VRF service 115 via a smart contract 110. The smart contract 110 then forms an input tag (INP) 103 of specific format and sends it to the VRF service 115. For example, the smart contract 110 may form the input tag 103 by combing other values, such as a signature, private keys, public keys, etc.

Any requester or user 100 first forwards their own input or randomness request 102 to the smart contract 110 along with the callback function 105 to be called with the VRF output 104. Upon receiving the response or VRF output 104 from the VRF service 115, the smart contract 110 verifies the VRF output 104, records the VRF output 104, invokes the provided callback function 105, and pays the VRF service 115. Specifically, when input or randomness request 102 from the requester 100 is sent to the smart contract 110, after verifying the input format and checking that the same value has not been requested previously, the smart contract 110 combines it with additional information (detailed below) to form the VRF input INP 103. The VRF service 115 then fetches the formatted request from the smart contract 110.

Each of the nodes of the service computes a partial evaluation of the user input by running the Part.Evalski (INP) and generates the (zero-knowledge) proof of correctness of the computation. At least t+1 partial evaluations are aggregated (typically using aggregator nodes) by running the Aggregate (·) algorithm after verifying the zero-knowledge proofs. The final VRF output and an accompanying proof are then sent to the smart contract, which verifies the correctness of the VRF output. If successful, it invokes the user-specified callback function with the VRF value as the input.

There are some practical issues with this conventional approach. For example, the VRF output appears on the public blockchain via the smart contract interaction immediately upon the protocol completion. This public nature of the VRF output puts significant restrictions on the way the requester can employ it. Specifically, the requester cannot make its request in advance towards having the randomness ready when the play or other operation begins. That is, the request must be synchronized with the application or VRF service. As a result, the use of publicly verifiable external randomness introduces a significantly latency overhead for the requester. The requester must put the play or operation on hold as it initiates and completes the VRF request.

Additionally, as the output is public, it cannot be re-used by the requester in the future (e.g., using a pseudo-random generator (PRG) to generate multiple random values to be used at different times when needed). This inability to reuse VRF requested values in the future also results in significant overhead with respect to gas cost and VRF service fees, as the requester has to make individual requests each time new randomness is required. This compels the requesting platforms to carefully design their games or services such that their players and clients cannot exploit the public VRF outputs, and furthermore, the latency and monetary overheads remain affordable. This limits the utility of smart contract-based VRF services significantly across the board.

### SUMMARY

Disclosed are systems, devices, and/or methods of use thereof regarding verifiable random function protocols in blockchain environments. Specifically, disclosed are system and methods in which only a requester of a random value can obtain the random output. Everyone else can see a blinded (aka masked) output, which only the requester can unblind. Crucially, anyone can still publicly verify that the requester's request was legitimate and ensure the legitimacy of the response (e.g., the final VRF output, when revealed, can still be verified as usual).

In various aspects, a method of generating a blinded random output includes executing a randomness request by a requester and sharing fractions of a key with a committee to generate partial evaluations of a random output. The method also includes aggregating the partial evaluations of the random output, generating a blinded public output corresponding to the randomness request, and sending the blinded public output to the requester, such that the requester may obtain the private random output.

In various aspects, a method of generating a private random output includes executing a randomness request by a requester for a future randomness need and sharing a key with a committee to generate partial evaluations of a random output. The method may also include aggregating the partial evaluations of the random output, generating a private public output corresponding to the randomness request, and verifying the private public output. Additionally, the method includes sending the verified private public output to the requester, such that the requester may obtain the private random output for the future randomness need.

In various aspects, a method of asynchronously obtaining a blinded random output includes sending a blinded randomness request for a random output and receiving a blinded public output corresponding to the random output. The method also includes privately obtaining the random output and generating one or more pseudorandom outputs from the privately obtained random output, the one or more pseudorandom outputs to be used immediately or for a future random need.

According to an embodiment of the invention, a method of generating a blinded random output is disclosed. The method may include executing a randomness request by a requester, sharing fractions of a key with a committee to generate partial evaluations of a random output, the partial evaluations being blinded, aggregating the partial evaluations of the random output, the partial evaluations of the random output also being blinded, generating a blinded public output corresponding to the randomness request, and sending the blinded public output to the requester, such that the requester may obtain the blinded random output.

According to the foregoing embodiment of the invention, the method for executing a randomness request by a requester may further include receiving a blinded input corresponding to the randomness request, generating an input tag, and sending the input tag to a verifiable random function service.

According to the foregoing embodiment of the invention, the method for receiving the blinded input corresponding to the randomness request may include receiving an input, creating a tagged input based on the received input, sending the tagged input to the requester, and receiving the blinded input and a proof of correctness for the blinded input.

According to the foregoing embodiment of the invention, the method for generating an input tag may include including a component of an identity of the requester.

According to the foregoing embodiment of the invention, the method for executing a randomness request by a requester may be executed by a smart contract.

According to the foregoing embodiment of the invention, the method may further include publishing the blinded public output on a blockchain via a smart contract without publishing the random output.

According to the foregoing embodiment of the invention, the method may require that only the requester can obtain the blinded random output.

According to the foregoing embodiment of the invention, the method may further include publicly verifying the blinded public output to ensure legitimacy of the blinded random output without making the blinded random output public.

According to the foregoing embodiment of the invention, the method for aggregating the partial evaluations of the random output may include receiving one or more partial evaluations verified through a proof and a secret-key fraction, eliminating incorrect partial evaluations, and combining one or more verified partial evaluations.

According to the foregoing embodiment of the invention, the method for generating a blinded public output corresponding to the randomness request may include combining the one or more partial evaluations and combining one or more proofs for equality of exponent to compute a value in a bilinear pairing.

According to another embodiment of the invention, a method for generating a private random output is disclosed. The method may include executing a randomness request by a requester for a future randomness need, sharing a key with a committee to generate partial evaluations of a random output, aggregating the partial evaluations of the random output, generating a private public output corresponding to the randomness request, verifying the private public output, and sending the verified private public output to the requester, such that the requester may obtain the private random output for the future randomness need.

According to the foregoing another embodiment of the invention, the method for aggregating the partial evaluations of the random output, generating a private public output corresponding to the randomness request, and verifying the private public output may occur publicly.

According to the foregoing another embodiment of the invention, the method for executing a randomness request by a requester for a future randomness need may include receiving an input by a user, sending the input back to the user for blinding to generate a private input, receiving the private input and a proof of correctness of the private input, and sending the private input and the proof of correctness to the committee.

According to the foregoing another embodiment of the invention, the method for executing a randomness request by a requester for a future randomness need may include receiving an input by a user, sending the input back to the user for blinding to generate a private input, receiving the private input and a proof of correctness of the private input, and sending the private input and the proof of correctness to the committee, and further include verifying the proof of correctness of the private input and computing partial evaluations of the random output.

According to the foregoing another embodiment of the invention, the future randomness need may be asynchronous to generation and verification of the private public output.

According to yet another embodiment of the invention, a method of asynchronously obtaining a blinded random output is disclosed. The method may include sending a blinded randomness request for a random output, receiving a blinded public output corresponding to the random output, privately obtaining the random output, and generating one or more pseudorandom outputs from the privately obtained random output, the one or more pseudorandom outputs to be used immediately or for a future random need.

According to the foregoing yet another embodiment of the invention, the method for sending a blinded randomness request for a random output may include sending an input to a server, receiving a created input from the server, blinding the created input to generate a blinded input, and sending the blinded input and a proof of correctness to the server.

According to the foregoing yet another embodiment of the invention, the method for receiving a blinded public output corresponding to the random output may include receiving a blinded value of a bilinear pairing, and unblinding the blinded value, wherein the unblinded value is used to privately obtain the random output.

According to the foregoing yet another embodiment of the invention, the one or more pseudorandom outputs may be used for a future random need asynchronously from sending the blinded randomness request for a random output.

According to the foregoing yet another embodiment of the invention, the blinded randomness request for a random output may be publicly verifiable for legitimacy without publishing the random output.

Other aspects of the disclosed subject matter, as well as features and advantages of various aspects of the disclosed subject matter, should be apparent to those of ordinary skill in the art through consideration of the ensuing description, the accompanying drawings, and the appended claims.

### BRIEF DESCRIPTION OF THE DRAWINGS

The accompanying drawing constitutes a part of this specification and illustrates an embodiment that, together with the specification, explains the subject matter.

FIG. 1 illustrates an embodiment of a conventional flow of messages for computing (distributed) verifiable random functions (VRFs) via smart contracts;

FIGS. 2 through 4 are flowcharts of example methods, according to embodiments of the present disclosure;

FIG. 5 illustrates an embodiment of flow of messages for computing output-private (distributed) VRFs via smart contracts;

FIG. 6 illustrates an embodiment of ideal functionality of a private VRF (Pri-VRF);

FIG. 7 illustrates a Pri-VRF construction according to embodiments of the present disclosure;

FIG. 8 illustrates an exemplary functionality of a private, distributed VRF (Pri-DVRF) according to an embodiment of the present disclosure; and

FIG. 9 illustrates an exemplary Pri-DVRF construction according to an embodiment of the present disclosure.

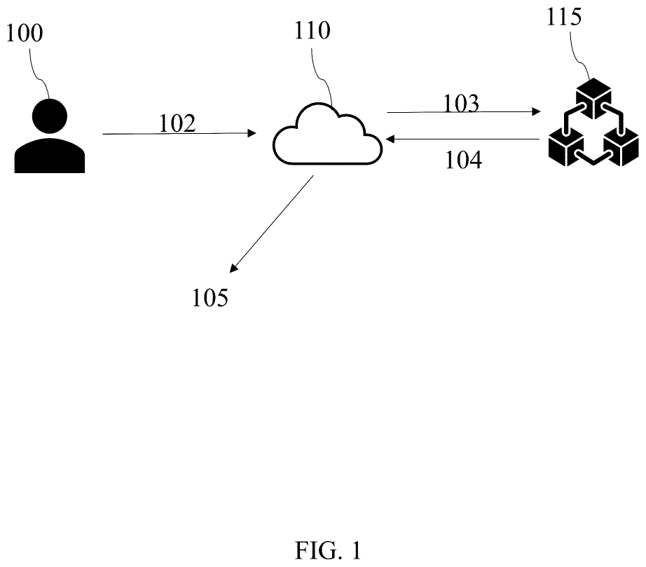

### DETAILED DESCRIPTION

The following detailed description is provided with reference to the drawing. Exemplary embodiments are described to illustrate the disclosure, not to limit its scope, which is defined by the claims. Those of ordinary skill in the art will recognize a number of equivalent variations in the description that follows without departing from the scope and spirit of the disclosure.

The present application addresses the crucial limitations of conventional VRF services by introducing a privacy primitive Output Private VRF (Pri-VRF). The introduction of a Pri-VRF adds significantly more flexibility to existing Web3-based VRF services. Additionally, utilization of Pri-VRF significantly reduces the monetary and overhead costs experienced using conventional Web3-based VRF services. The Pri-VRF of the present disclosure is capable of maintaining or preserving the pseudo-randomness and public verifiability properties of conventional VRFs while ensuring that only the requester, alone, of the random output can observe the VRF output. The smart contract through which the VRF is executed (and anybody else) can only observe a blinded-yet-verifiable version of the output.

As the VRF service, with its ownership of the secret-key, becomes a single point of failure, a solution of the present disclosure is to utilize a distributed VRF (DVRF) with the key secret-shared across distinct nodes in the framework. The DVRF has a provable security analysis (in Universal Composability) and introduces only minimal computation and communication overhead for the VRF service, the requester, and the contract.

Output-private VRF (Pri-VRF) allows the requester to overcome the above-mentioned restrictions. As the public value is blinded, the requester can compute the necessary randomness asynchronously (i.e., ahead of time) to be used at any later point as needed. Furthermore, due to the privacy aspect, one may extend the private output y=Vsk (x) to generate multiple pseudorandom values z₁=PRG(y, 1), z₂=PRG(y, 2), . . . using a pseudorandom generator. The random values z₁, z₂ can be used (asynchronously) at a later point when needed. It thus can offer a cost-efficient randomness generation mechanism.

In conventional VRF systems and services, the computing node (which knows the secret-key and computes the VRF output) becomes a single point of failure for secrecy as well as liveness. That is, the VRF outputs are completely predictable to this node and the VRF computation discontinues if the specific node crashes. Thus, utilization of a decentralized VRF (DVRF), an extension of VRF in a decentralized setting, provides a secure, live, and secret framework for VRF outputs.

In contrast to conventional centralized VRFs, in a DVRF framework, no single node has access to the entire secret-key. Specifically, the secret-key is shared among many parties (P₁, P₂, P₃ . . . Pₙ, etc.) which together are referred to as the VRF committee. The secret-key may be shared using Shamir's secret sharing scheme, implemented using an appropriate Distributed Key-generation protocol.

On an input x, each party Pᵢ computes a partial evaluation-proof pair (yᵢ, πᵢ) using their shares or fractions of secret-key skᵢ. An aggregator, possibly one of the servers in the VRF committee, may not hold any secret-key and can publicly gather t+1≤n such partial evaluations to aggregate them into the final output y and an accompanying proof. This procedure is public. A t out of n distributed (threshold) procedure is, in fact, resilient to ƒ≤t malicious corruptions, which may collude. Therefore, compared to the centralized setting, this setting provides several enhanced guarantees: (i) consistency, which guarantees that any t+1 parties may collaborate to produce a unique and consistent output y; (ii) robustness, ensuring that if there is a wrongly computed partial evaluation, it must be detected before aggregation; and (iii) liveness (alternatively availability), which ensures that corrupt parties cannot prevent the output from being computed. Furthermore, the pseudo-randomness guarantee is now much stronger, as it must be achieved in the presence of ≤t malicious corruptions.

The Pri-VRF of the present disclosure extends to the t out of n distributed setting (Pri-DVRF). This extension is analogous to distributed VRFs, with added privacy guarantees. In addition to the guarantees mentioned earlier, Pri-DVRF requires output privacy, even when St servers are malicious. Thus, each server now computes a partially blinded value, which is aggregated publicly (possible only if there are ≥t+1 legitimate responses), and then the final blinded y is sent to the requester, which then unblinds it to obtain y. All DVRF guarantees must hold on to the blinded values. The Universal Compatibility (UC) definitions formally capture all of these informal guarantees.

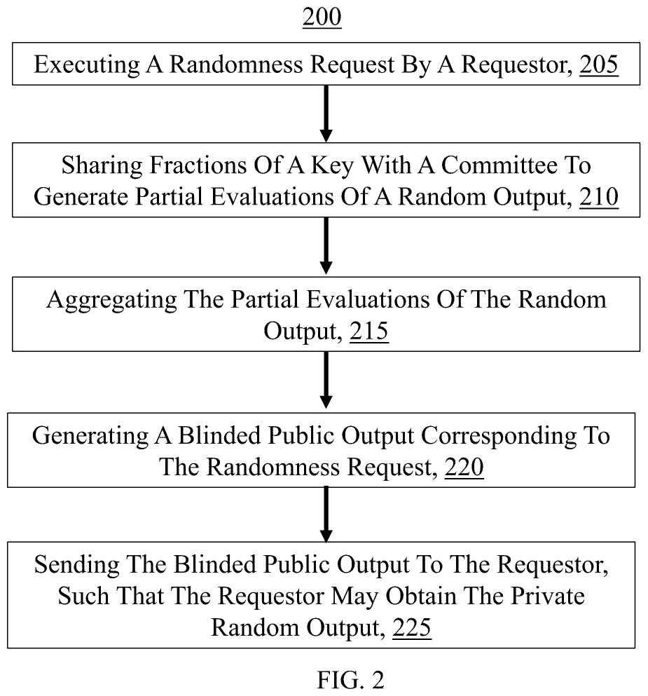

FIGS. 2 through 4 are flowcharts of example methods according to embodiments of the present disclosure. Specifically, FIG. 2 illustrates a method 200 of generating a blinded random output, where only a requester of the output can obtain the blinded random output. The method 200 may include executing a randomness request by a requester, at 205, and sharing fractions of a key with a committee to generate partial evaluations of a random output, the partial evaluations being blinded, at 210. The method 200 may also include aggregating the partial evaluations of the random output, at 215, and generating a blinded public output corresponding to the randomness request, at 220. Furthermore, the method 200 may include sending the blinded public output to the requester, enabling the requester to obtain the private random output, at 225.

The method 200 may also include publicly verifying the blinded public output to ensure legitimacy of the blinded random output without making the blinded random output public. Subsequently, the blinded public output may be published on a blockchain via a smart contract, without publishing the random output. This allows the outputs to be verified as legitimate, while preserving secrecy, guarantees, and asynchronous usage of the (publicly verified) private outputs.

In some embodiments, executing a randomness request by a requester may include receiving a blinded input corresponding to the randomness request. For example, the request may be transmitted by a smart contract to a server or node within the DVRF framework, which then receives a blinded input from a requester. The blinded input may be a concatenation of various values, such as: (i) the user input (e.g., the user's chosen input, which may be empty); (ii) a block-hash, incorporated to prevent anyone from requesting the input before the block-hash is computed, thereby thwarting pre-computation of a VRF output for future use; (iii) a unique nonce, ensuring the distinctiveness of each VRF input (generated at the specific smart contract each time a VRF is called, where the smart contract must maintain a state or counter); (iv) chain ID, distinguishing inputs generated on two different blockchains (e.g., Ethereum versus Solana); (v) user address, providing user-specific information to further distinguish between requests from different users; (vi) callback function name, used to distinguish between two different functions originating from the same user at approximately the same time; and/or (vii) a flag indicating VRF of Pri-VRF, crucial for distinguishing between a Pri-VRF and VRF (without this, a PVRF request might be maliciously processed as a DVRF, potentially exposing the output). Additional or other values may be included as necessary.

The requester may represent various entities, such as a gaming platform, a gambling platform, or any other platform within the blockchain environment that requires a random value. Furthermore, executing the randomness request may involve the generation of an input tag, followed by sending this input tag to a verifiable random function service. In some embodiments, the randomness request is executed by a smart contract.

In some embodiments, receiving the blinded input corresponding to the randomness request includes receiving an input, followed by the creation of a tagged input based on the received input, which is then sent to the requester. Additionally, receiving the blinded input may encompass obtaining both the blinded input and a proof of correctness for the blinded input. The proof of correctness could take the form of a non-interactive zero-knowledge (NIZK) proof of knowledge of exponent. The process of generating an input tag may include incorporating a component of the requester's identity into the input tag.

Aggregating the partial evaluations of the random output may include receiving one or more partial evaluations, each verified through a proof and a secret-key share or fraction. The secret-key fraction may be held or known by one or more members of the DVRF committee (e.g., one or more nodes within the DVRF framework). Similar to before, the proof for verifying these partial evaluations may be an NIZK proof of knowledge of exponent. Additionally, the process of aggregating the partial evaluations may include several steps, such as eliminating incorrect partial evaluations and combining verified partial evaluations. Subsequently, generating a blinded public output corresponding to the randomness request may include combining the one or more partial evaluations and combining one or more proofs for equality of exponent to compute a value in a bilinear pairing.

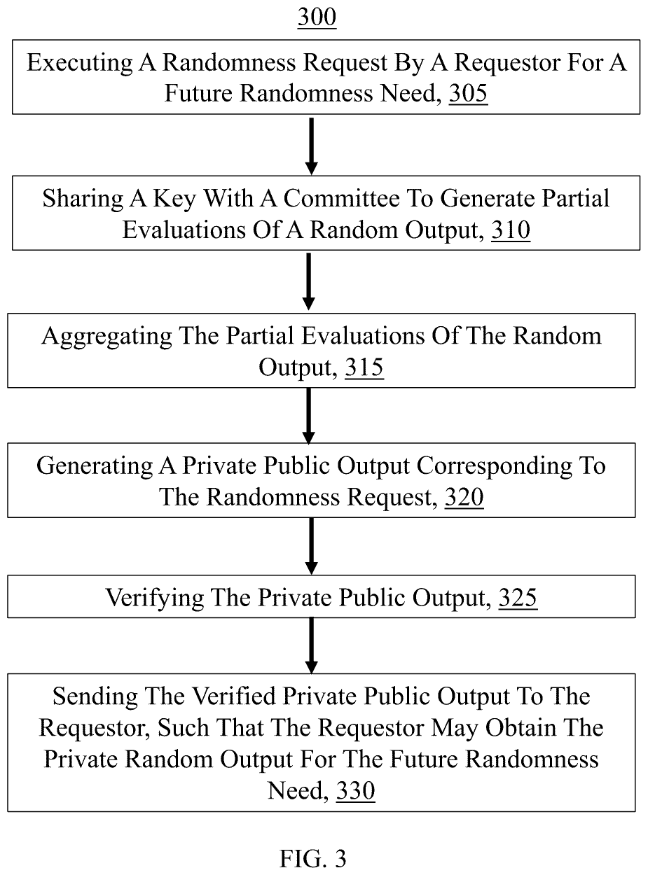

FIG. 3 illustrates a method 300 of generating a private random output. The method 300 may include executing a randomness request by a requester for a future randomness need, at 305. That is, the randomness request may be for a random output to be generated upon request but used at some point in the future, rather than immediately. This asynchronous nature of the method allows requesters to avoid latency and synching issues, thereby significantly reducing costs in terms of time and money. Additionally, the generated random output are capable of being publicly verified and subsequently used at a future time.

The method 300 may also include sharing a key with a committee to generate partial evaluations of a random output, at 310, and subsequently aggregating these partial evaluations, at 315. Furthermore, the method 300 includes generating a private public output corresponding to the randomness request, at 320, and subsequently verifying the private public output, at 325. Additionally, the method 300 may include sending the verified private public output to the requester, such that the requester may obtain the private random output for the future randomness need, at 330.

The process of aggregating the partial evaluations of the random output, generating a private public output corresponding to the randomness request, and verifying the private public output all occur publicly. Despite this public verification, only the requester of the randomness request can obtain the private random output, ensuring the secrecy and true randomness of the private random output while still allowing verification. Public verification instills trust in the randomness. In some embodiments, executing a randomness request by a requester for a future randomness need includes receiving an input by a user or a requester, sending the input back to the user or requester for blinding to generate a private input.

Moreover, executing the randomness request includes receiving the private input and a proof of correctness of the private input (such as an NIZK proof of knowledge of exponent) and sending the private input and the proof of correctness to the committee. Additionally, executing the randomness request includes verifying the proof of correctness of the private input and computing partial evaluations of the random output.

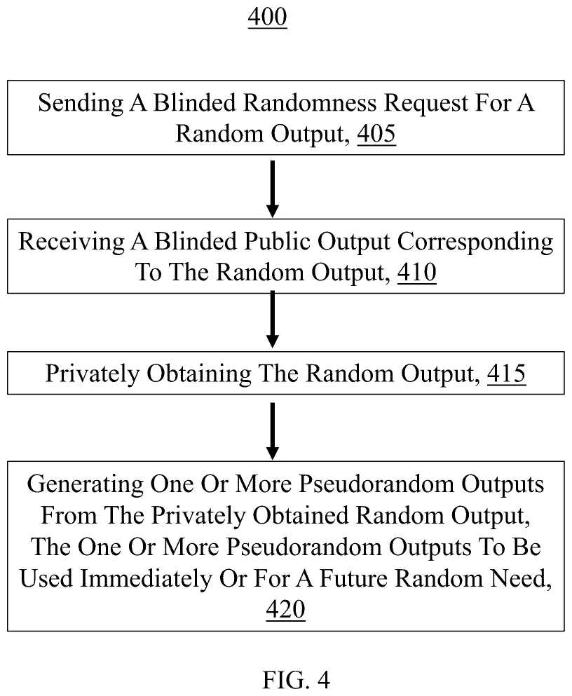

FIG. 4 illustrates an exemplary method 400 of asynchronously obtaining a blinded random output according to an embodiment of the disclosure. The method 400 begins with sending a blinded randomness request for a random output, at 405. Subsequently, at 410, the method involves receiving a blinded public output corresponding to the random output. Then, at 415, the random output is privately obtained. Following this, at 420, one or more pseudorandom outputs are generated from the privately obtained random output, intended for immediate use or future random needs. These pseudorandom outputs can be used asynchronously from the time the blinded randomness request for a random output is sent. Importantly, the blinded randomness request for a random output remains publicly verifiable for legitimacy without publishing the random output.

Sending a blinded randomness request for a random output may include several steps. Initially, an input is transmitted to a server and/or a smart contract. Upon receiving a created input from the server or the smart contract, this input is then blinded to generate a blinded input. Subsequently, the blinded input and a proof of correctness are sent to the server (e.g., an NIZK proof of knowledge of exponent). In some embodiments, the process of receiving a blinded public output corresponding to the random output may include receiving a blinded value of a bilinear pairing. This blinded value is then unblinded, resulting in an unblinded value that is used to privately obtain the random output.

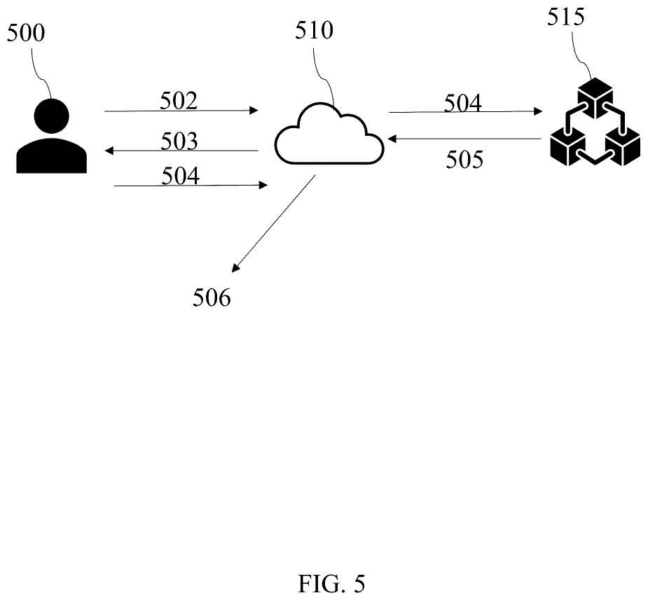

FIG. 5 illustrates a flow of messages for computing output-private (distributed) VRFs via smart contracts, a process applicable to any of the methods 200 through 400. The message flow is highly practical, taking less than 0.5 msec for partial evaluation on each VRF node in a single-threaded implementation. This time duration is comparably low when compared to the non-private DVRF, which takes 400 μsec (vs 253 μsec) for the 256-bit (BN256) curve using the mcl library. The requester takes approximately 300μ see for blinding and generating the zero-knowledge proof of correct blinding before transmitting it to the VRF service.

A change in the Pri-DVRF framework occurs during the initial phase when the smart contract 510 returns an input 503 to the requester 500 for blinding. Subsequently, the requester 500 sends a blinded input 504 (along with a NIZK proof of knowledge of exponent) back to the smart contract 510. The smart contract 500 is capable of executing a VRF protocol and verification on the blinded input 504. The smart contract 510 forwards the blinded input 504 to the VRF committee 515, which then generates the output 505 based on the blinded input 504.

More specifically, in the Pri-DVRF framework, a requester 500 sends a request 502 to the smart contract 510, which then crafts an input (INP) 503 composed of many parameters crucial for preventing attacks. That is, the smart contract 510 creates the input 503, based on feedback received from the servers or VRF committee 515, which is sent back to the requester 500 for blinding. The input 503 is blinded by the requester 500 to create a blinded input 504. In some embodiments, the input 503 may be blinded through Hash (INP)^{{b}}, where b=blind. Subsequently, the smart contract 510 sends the blinded input 504 to the VRF committee 515, where the servers (e.g., the VRF committee 515) interact to produce an output 505. This output 505 is then transmitted back to the smart contract 510. Upon successful verification of the output 505, the contract 510 forwards it to the requesting platform 506.

One way to break the privacy of the blinded input may be to observe the input x and then make the same request, pretending to be the “owner” of x, and legitimately derive y. The framework prevents this by carefully crafting the input INP such that it includes a component reflecting the requester's identity (for example, the requester's public key). This can be checked at the server or smart contract's end to avoid such an attack. This is incorporated in the present disclosure by assuming a unique owner for an input and is captured within the UC definition.

For example, consider a bilinear pairing group structure e: G₁×G₂→G_{T}, each a cyclic group of prime order p. The VRF secret-key sk is chosen at random from Zₚ, whereas the public verification key vk is pair of group elements (vk₁=g^{sk}₁, vk₂=g^{sk}₂) where g₁, g₂ are random generators of groups G₁ and G₂, respectively.

A requester with an input x first blinds their input to generate ψ=H₁(x)^{ρ}∈G₁ for a hash function H₁(·), whereas ρ is a random blind/mask in Zₚ. The requester then produces a NIZK proof of knowledge of ρ (using Schnorr's proof for knowledge of exponent), and sends it to the smart contract, which forwards it to the VRF server.

The server first verifies the NIZK proof, and if successful, sends back \tilde{y}=(H₁(x)^{ρ})sk. The contract verifies the response by using bilinear pairing e (ψ, g^{sk}₂)=e (\tilde{y}, g₂) (similar to Boneh-Lynn-Shacham (BLS) signatures). If successful, the contract forwards \tilde{y} to the requester, who then unblinds to get π=\tilde{y}^{1/ρ}=H₁(x)^{sk}, then derives y as H₂(π).

The final VRF verification involves running the BLS verification, but with different components: e (H₁(x), g^{sk}₂)=e (π, g₂) plus the hash H₂(π)=y. It is important to note that there are three verifications in total: one for the requester's message, one for the server's message, and finally, one for the VRF triple—all of which can be done publicly. Furthermore, using these three verifications together, one could verify not only that the output y is correct but also that the entire flow of communication with the input x is associated with the output y.

The centralized solution can be extended to a t out of n setting by using a VRF committee consisting of n nodes, each of which holds a secret-key share or fraction skᵢ of sk (this can typically be achieved through a distributed key generation (DKG) protocol). The verification key now is of the form vk=(pk=g^{sk}₂, vk₁=g^{sk1}₁, vk₂=g^{ski}₁, . . . ). The requester's steps remain identical—in fact, the requester may be completely agnostic of whether a centralized or a decentralized service is being used (or what n, t are being used). The smart contract now sends the blinded request to each server in the committee.

Once a VRF server within VRF committee receives a blinded request up along with x and a NIZK proof, each server checks the proof as before. If successful, it then uses its share or fraction skᵢ to compute a partial value wᵢ=ψ^{sk}ᵢ. Additionally, it computes another NIZK for equality of exponent (e.g., using Chaum-Pederson) between wᵢ and vkᵢ. The server then sends the partial evaluation wᵢ along with the proof to the aggregator, who verifies each NIZK proof. If at least t+1 of them succeed, the aggregator combines the corresponding partial evaluations via Lagrange interpolation in the exponent to compute \tilde{y}=H₁(x)^{ρ·sk}. Given x,ψ,ey, the smart contract verifies using the bilinear map and then sends that over to the requester on success.

The overall computational overhead for the VRF committee servers is less than 2× compared to GLOW-DVRF, and is incurred due to the blinded-input NIZK verification by each server. GLOW-DVRF is an abbreviation for a distributed verifiable random function (“DVRF”) disclosed in a paper titled, “FULLY DISTRIBUTED VERIFIABLE RANDOM FUNCTIONS AND THEIR APPLICATION TO DECENTRALIZED RANDOM BEACONS,” authored by David Galindo, Jia Liu, Mihai Ordean, and Jin-Mann Wong (“GLOW”). Importantly, in the DVRF framework of the present disclosure, the smart contract's work is similar or substantially the same (a single pairing computation) and hence the gas cost remains the same or substantially the same.

Consistency is ensured using Shamir's secret sharing. Robustness is ensured by the soundness of NIZK proof of equality computed during partial evaluations. The setting is restricted such that n≥2t+1. This, combined with robustness, ensures liveness. The pseudo-randomness of the present constructions requires that, if the server is not corrupt, no one else can predict the output y unless explicitly obtained from the server. For the distributed setting, the same should hold even if at most t servers are maliciously corrupt additionally.

The methods of the present disclosure relies on a similar assumption, namely a variant of (threshold) one-more Diffie-Hellman (DH) assumptions. However, due to the bilinear pairing groups, version that holds in a pairing source group is required. Nevertheless, in contrast to them, a gap version is not necessary due to the presence of bilinear pairing. The output-privacy part is new to this setting and is carefully handled using the Computation Diffie-Hellman (CDH) assumption over bilinear groups (known as Co-CDH). This part works because of the unpredictability of H₁ (x)^{sk}, given g^{sk}₁, H₁ (x)^{sk·ρ} and H₁ (x)^{ρ} (in the centralized case), which is similar to the proof of BLS signature unpredictability but requires more care due to exposure of many exponents of H₁ (x). When the server is compromised (in the decentralized case, that is equivalent to corruption of >t servers), then the only guarantee would be that the output y is correct, although not unpredictable—this is not hard to see because of the soundness of the NIZK proof (in the decentralized setting) or correctness of bilinear pairing (for centralized case). All hash functions are modelled as random oracles and are carefully programmed into the proofs.

There are alternative approaches, such as encryption plus the NIZK proof. One way to generically convert any (D) VRF to a Pri-(D) VRF is to use (fully homomorphic) encryption and any non-interactive zero-knowledge proof (NIZK): the requester simply sends the input to the VRF committee (via the smart contract) which computes the partial evaluations and provides a NIZK proof of correct evaluations. The aggregation can be done using homomorphism (for some constructions, additive homomorphism may suffice) plus by producing another succinct NIZK (such as succinct non-interactive argument of knowledge (SNARKs)) of correct verification of at least t+1 ciphertexts. While this may be a potential solution, the efficiency of this may be significantly worse than the presently disclosed approach. In particular, producing an NIZK proof of a specific encryption scheme (even efficient ones such as ElGamal) already adds significant overhead; on top of that, producing an aggregated proof during aggregation seems to incur even more computational inefficiency. Of course, this approach may be reasonably efficient (though still probably much behind a centralized version) in the centralized setting, but this is not a scheme that easily supports decentralization.

In some embodiments, bilinear paring verification can be replaced with NIZK verification. In such embodiments, the server would send π as above, plus a NIZK proof of the equality of exponent with g^{sk}₁ (e.g., Chaum-Pederson's proof). The issue here is that the requester cannot have a publicly verifiable triple (x,y,π), as the NIZK proof does not immediately support the “homomorphism” in bilinear pairing like above. Furthermore, such an approach would not be easy to decentralize because the NIZK proofs must be aggregated using, for example, a SNARK proof, leading to a significant challenge in terms of constructing an efficient SNARK for that specific language. In contrast, the approach of the present disclosure is readily extendable into a decentralized setting.

An alternative to using Chaum-Pederson's NIZK could be to use bilinear pairing for verifying a server's response, akin to a centralized construction. However, this would incur a computational overhead of about 2.5× compared to the NIZK proof—as in the case for Dfinity-DVRF vs GLOW-DVRF. This is because the NIZK proof works in the group G₁ and supports faster operation than bilinear pairing. The concept of using Chaum-Pederson's proof for verifying the server's partial response during aggregation can also be incorporated in the centralized setting (albeit the final verification of (x,y, π) should still be done using pairing). However, in practice, the benefit is much less as only one pre-verification is done compared to at least t+1 pre-verification performed in the distributed setting. Thus, the centralized construction remains simple, and the use of the NIZK-based optimization is only in the distributed version (though it can be realized as a special case: n=1, t=0).

In the distributed setting, no server alone holds the entire secret-key. Instead, the VRF secret-key sk is distributed among multiple parties. The set of n servers, denoted as S={P₁, . . . , Pₙ}, jointly hold a VRF key sk jointly in a t out of n fashion, for example using a secret-sharing scheme. Now, even if t servers are compromised (and potentially collude with each other), the key remains hidden from the adversary. Any client then can then interact with t+1 servers to evaluate y=Vₛₖ(x) and an associated proof π privately, such that no one except the client knows y or π. More concretely, the client sends a message containing the input x to all servers in the set S. As long as t+1 replies correctly with blinded responses, the client should be able to aggregate the responses to compute an aggregated blinded response. Later, the client can unblind to obtain the output proof pair (y, π), where y must be pseudorandom and publicly verifiable (and remains so even if sk is completely leaked), even when up to t parties are controlled by a malicious adversary.

However, in addition to these standard VRF properties, more properties are needed in the distributed setting. First, consistency is needed, meaning that the final output y is independent of the participating set. Availability or liveness is also necessary, ensuring that regardless of the actions of malicious parties, the protocol will execute correctly (also known as guaranteed output delivery). Achieving these two requirements is straightforward: the first by using a t out of n secret sharing scheme, such as Shamir's, and the second one by assuming n≥2t+1, which is ensured within the ideal functionality F_{pdvrf} (described elsewhere).

Another requirement is robustness, which ensures that if the aggregation is successful, then the final verification would also be successful. This is encompassed within the ideal functionality by implementing a partial pre-verification mechanism, which ensures that any incorrect response from a server can be detected during aggregation. Similar to the Pri-VRF setting, multiple parties are assumed, any of which can fulfill the roles of server or client for any given execution. A group of parties can collaborate to execute a key-generation to have a common (public) verification key vk and shares sk₁, sk₂, . . . of a secret-key sk.

### Definitions and Notations

As disclosed herein, N is used to denote the set of positive integers, Z denotes the set of all integers, and [n] denotes the set {1, 2, . . . , n} (for n∈N). A tuple of values is represented by the vector notation v=(v₁, v₂ . . . ). For a boolean vector v∈{0, 1}ⁿ, its hamming weight is given by the number of 1s in v. For any set S, |S| denotes its cardinality. The security parameter is denoted by κ. It may be assumed that every algorithm takes κ as an implicit input, and all definitions work for any sufficiently large choice of κ∈N. The security parameter is not explicitly stated except in a few instances. negl(κ) denotes a negligible function in the security parameter; a function ƒ: N→N is considered negligible if for every polynomial p, it holds that ƒ (n)<1/p (n) for all large enough values of n. Similarly, poly(κ) denotes a polynomial function of the security parameter κ. D(x)=: y or y: =D(x) denotes the evaluation of a specifically deterministic algorithm D on input x to produce output y. Often x:=val denotes the assignment of a value val to the variable x. R(x)→y or y←R(x) denotes evaluation of a probabilistic algorithm R on input x to produce output y. Primarily, probabilistic polynomial time (PPT) algorithms are considered, which are randomized and execute in polynomial time. For a boolean condition b: =(x=y), it is denoted that if x=y is satisfied, b gets the value 1, otherwise, if x≠y and the check fails, it gets the value 0.

When a problem is referred to as “computationally hard,” it implies that given a problem instance, generated using the security parameter κ, for any probabilistic algorithm ‘A that operates in O(poly(κ)) time, the probability of ‘A solving the given problem instance is upper-bounded by ≤negl(κ).

A polynomial P(x) over a finite field F of degree t can be expressed as P(x)=c₀+c₁x+c₂x² . . . cₜx^{t}, where each coefficient is in F. Given any l≥t+1 evaluation points P (j₁), . . . , P (jₗ), where S={j₁, . . . , jₗ}, there are scalars λ_{i,j,s} such that for any i∈N: P(i)=Σⱼλᵢ, _{j,S}P (j). Importantly, the Lagrange coefficient λ_{i, j,S} corresponding to j depends only on the set S and the evaluation point at i.

For compact presentation, an on-the-fly random function, denoted Rand (·), is used in the Pri-VRF and Pri-DVRF definitions. For a given domain Dom and Rng, the function has a table T containing pairs (x,y) where x∈Dom and is initialized to Ø. It works as follows:

$$Rand ( x ∈ Dom ) .$$

If there exists (x,y)∈T, return y. Otherwise, return to a uniform random y←$ Rng and append (x,y) to T.

The methods and models of the present disclosure utilize the Universal Compatibility (UC) framework, wherein a real-world multi-party protocol realizes an ideal functionality. Similar to the simplified UC framework, the present disclosure assumes the existence of a default but authenticated channel in the real world. This significantly simplifies the definitions and can easily be removed using an ideal authenticated channel functionality.

### EXAMPLES

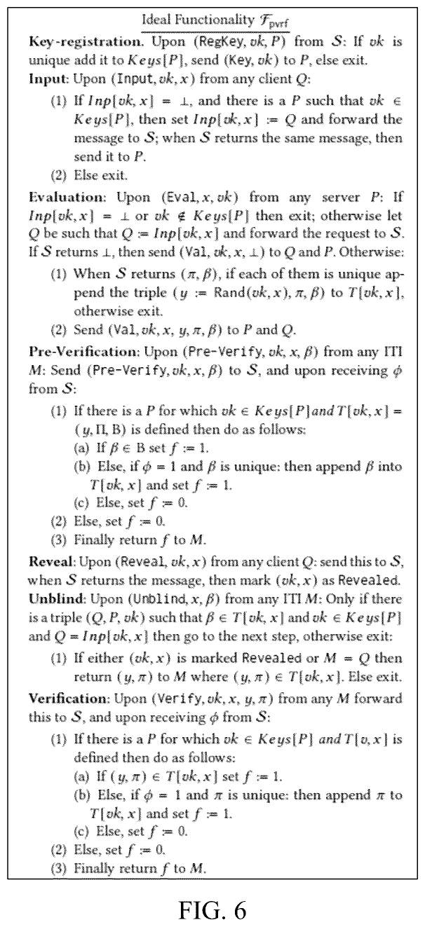

FIG. 6 illustrates an ideal functionality of a private VRF (Pri-VRF), which captures all guarantees, according to an embodiment of the present disclosure. The ideal functionality interacts with parties, generally denoted by P and a simulator S. The phrase “any ITI”, denoted by M, refers to either a party P or the simulator S. The ideal functionality keeps track of the following variables, all of which are initialized to ⊥ (or Ø) implicitly.

Keys [M]: contains the verification keys owned by any ITIM. A verification key vk is unique if there exists a unique M, for which vk∈Keys [M].

T[vk, x]: contains entries of the form (y, Π, B) corresponding to a verification key vk and an input x. Each entry contains an output y, and sets Π={π₁, π₂, . . . }, B={β₁, β₂ . . . } etc. The set Π contains all proofs for the tuple (vk, x,y), whereas the set B contains the corresponding server messages. A proof π is unique whenever there exists a unique pair (vk, x) such that π∈T [vk, x]. Similarly, uniqueness of transcript and a pair (π, β) are defined. Appending (π, β) to a list T means that updating the sets Π: =Π∪{π} and B: =B∪{β}. When the list T [vk, x] is defined, that implies T [vk, x]≠⊥.

Inp [vk, x]: Contains identity of a party, who is the sender/client for the execution specific to (vk, x). If Inp [vk, x]=Q, that implies Q holds the input x in the execution.

Session ID has not been included for simplicity. However, note that an execution session can be uniquely identified by a pair (vk, x) due to the uniqueness criteria, which makes a session ID redundant. The output-privacy requirement is captured by replacing the output with another variable β, which acts as a placeholder for the server's message and is used in the pre-verification. For the same purpose, two phases have been introduced: a Reveal and Unblind phase. Two queries, Eval and RegKey, have been merged, involving the simulator and any other party, as the simulator controls the corrupt parties and can make those queries through them.

In the real world, a structured protocol execution is assumed. Towards that, consider the following set of algorithms:
Keygen (1^{κ})→(sk, vk): The key-generation algorithm outputs a pair of keys (sk, vk)—sk is the secret-key and vk is the verification key
Blind (1^{κ}, x)→(st, \ddot{x}): This algorithm processes the input x to offer a secret state st and a public output x
InpVer(1^{κ}, (x, \ddot{x}))=: I/O. The input verification algorithm verifies whether the pair (x, \ddot{x}) is correctly computed, and returns 1 if and only if the check succeeds
Eval (vk, sk, \ddot{x})→\tilde{y}: The evaluation algorithm uses the secret-key sk (and possibly also the verification key vk) on the blinded input x to produce a blinded output \tilde{y}
Pre Ver (vk, (x, \ddot{x}, y))=: 1/0: The pre-verification algorithm verifies whether the computed blinded value \tilde{y} is correct for the pair (x, \ddot{x}) and verification key vk
Unblind (x, \tilde{y}, st)=: (y, π): The deterministic unblinding algorithm takes a blinded output \tilde{y} and a secret-state st (typically generated during the blinding procedure) plus an input x as inputs and outputs an output-proof pair (y, π)
Verify (vk, (x,y, π))=: I/O: The verification algorithm takes the public verification key vk and a pair (x,y) as input and outputs a decision bit

In a real-world scenario with parties connected by pairwise authenticated channels, any party Pₛ may run Keygen and publish a verification key vk while keeping the secret-key sk private—Pₛ will be referred to as a server. Any other party P_{c} may have an input x and is termed a client—aiming to derive a VRF y=Vₛₖ (x). A party can act as a server or a client in different executions. The client runs Blind and sends the pair (x, \ddot{x}) to the server, which initially verifies whether the blinded input was correctly computed using Inp Ver on the pair (x, \ddot{x}). In fact, this check can be performed by anyone. If the verification succeeds, the server proceeds to execute Eval on \ddot{x} to generate \tilde{y} and subsequently transmits it to P_{c}. Anyone (may or may not be the same as P_{c}) can then run PreVer on (vk, \ddot{x}, y) to publicly verify whether the server's computation was correct. At any stage, the client may unblind by executing Unblind on (x, \tilde{y}) to get the final output-proof pair (y,π). Once the pair (y, π) is made public, anyone can verify whether y was correctly computed from x by publicly running Verify on (x,y,π). Importantly a combination of the checks Verify, PreVer, and InpVer together enable public verification of the entire transcript (x, \ddot{x}, \tilde{y}, y).

Let Π be a protocol that operates as described above and provides the algorithm specifications. Then, Π UC-realizes the ideal functionality F_{pvrf} if for any real-world static, malicious PPT adversary A, there exists a PPT simulator S in the ideal world such that for all environment E:

$${Real}_{\prod , A , E} \approx {c}^{Ideal} {F}_{pvrf} , S , E$$

It is also assumed that in the protocol, each input x is unique to a client who provides it. Therefore, if client Q provides input x, Q is referred to as the client. Without this assumption, one may consider the following attack. Another client Q′ observes the input x and separately executes a legitimate VRF protocol to compute y, which is not desirable. This uniqueness can be ensured by appending the unique party identity to the input, which would be checked during evaluation by each server. This is possible due to the presence of pairwise authenticated channels. Note that in the ideal functionality, the ownership is with respect to the session, defined by (vk, x), and formalized by Inp [vk, x]. So, the protocol would provide a slightly stronger guarantee than what is required by the definition.

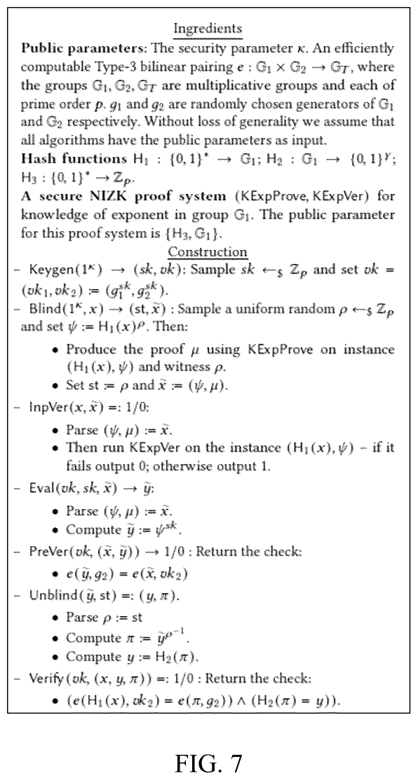

FIG. 7 illustrates a Pri-VRF construction according to embodiments of the present disclosure. This construction is based on a non-threshold version of the BLS-based DVRF, and it satisfies the Pri-VRF of the present disclosure, as captured by the Pri-VRF ideal functionality of FIG. 6.

The construction of FIG. 7 proves the following theorem: it utilizes UC—realizes F_{pvrf} with overwhelming probability as long as the one-more bilinear Diffie-Hellman (BDH) assumption (BOMDH) and the Co-CDH assumption hold over the underlying bilinear groups; the hash functions are modeled as random oracles; and the underlying NIZK proof is secure (which requires an external Diffie-Hellman (XDH) assumption over the same groups).

Consider a case including three (3) parties, each performing specific tasks: a client P_{C} which sends/receives inputs, a server P_{S} which holds VRF keys and performs evaluations, and an eavesdropper P_{E} which has no input, and observes the communications (assume authenticated but no secure channels). All three parties may perform public operations such as verifications based on the publicly available values. Three distinct simulators are constructed: S_{E}, S_{S}, and S_{C}, for three distinct cases—an eavesdropper, a server, and a client. This is without loss of generality because, in a multiplayer scenario, any corruption can be simulated by a combination of these when a party can act as any of the three roles or a combination thereof. Nevertheless, for a particular execution defined by (vk, x), a party can have only one of the three roles: the input provider (providing x) is a client, the VRF-evaluator (owning the key vk) is a server, and everyone else is an eavesdropper. Therefore, for any scenario, the generic simulation strategy would be to identify the role of each corrupt party corresponding to an execution and then use the corresponding simulation strategy from above as a sub-routine.

For example, consider a scenario involving three (3) parties: a client, a server, and an eavesdropper. Correspondingly, consider three scenarios or a particular execution with a fixed (vk, x), in each of which there is exactly one corrupt party. When only the eavesdropper is corrupt, “output-privacy” becomes a desirable guarantee. That is, no eavesdropper can learn the VRF output until it is revealed, even if it can access the input x, the verification-key vk, and the entire transcript. It can be demonstrated that, in this case, the simulator can simulate communication between the honest server and the honest client in a manner that is computationally indistinguishable from the real world, as long as Co-CDH holds in the underlying bilinear paring group and the NIZK proof is zero-knowledge. This argument can be supported by providing an explicit reduction to Co-CDH (along with the zero-knowledge property of the NIZK).

For example, the S_{E} simulates an honest client P_{C} and an honest server P_{S} as honest parties and also simulates all random oracle (RO) queries. The server executes Keygen to generate (sk, vk) and registers vk∈Keys [P_{S}]. When the server receives the message (Input, vk, x) from the ideal functionality, the server generates uniform random p and correctly computes the blinded input xe. The blinded input is then given to the adversary (corrupt P_{E}). From the server side, the simulator computes ye correctly and knows sk. So the corrupt eavesdropper obtains the following values before unblinding:

$$public key vk = ( {vk}_{1} = {g}^{{sk}_{1}} , {vk}_{2} = {g}^{{sk}_{2}} )$$

$$input x , and subsequently {H}_{1} ( x ) through RO query$$

$$blinded input ψ = {{H}_{1} ( x )}^{ρ} and the NIZK proof μ$$

$$blinded output ye = {{H}_{1} ( x )}^{ρ sk}$$

After the unblinding phase, the adversary (P_{E}) additionally gets y=H₂(π) and π=H₁(x)^{sk}. The simulator gets only a uniform random y after making an explicit unblinding query on β=ye, namely (Unblind, x, β) to the ideal functionality. So the simulator must program y as H₂(π). This can be done as long as the adversary makes a random oracle query after the unblinding phase. However, if the simulator receives a random oracle query on H₂(π) before the unblinding phase, then the program fails. This is because the only way for the simulator to obtain (y, π) is through an explicit Unblind query. In particular, since both P_{C} and P_{S} are honest, the simulator does not get the output during Eval or by any other means. Prior to the unblind phase, there was no (Reveal, vk, x) query from the honest client, and hence, at this point, the pair (vk, x) is not marked Revealed. Consequently, the simulator cannot obtain y. A successful simulation requires proving that the probability that the eavesdropper can predict the value π=H₁(x)^{sk} (and subsequently make a RO query with that) must be negligible. Unless it is negligible, a PPT algorithm can be constructed to break the co-CDH assumption over bilinear groups with non-negligible probability.

The reduction's goal is to compute h^{sk}₁, given a co-CDH instance g₁, g^{sk}₁, h₁∈G₁; g₂, g^{sk}₂∈G₂ for uniform random generators g₁, h₁, g₂ and a uniform random field element sk∈Zₚ. To compute h^{sk}₁, the reduction simulates as follows. If sk is the implicit secret-key of the scheme, then vk₁=g^{sk}₁ and vk₂=g^{sk}₂ and vk: =(vk₁, vk₂) is the verification key. Importantly, the reduction cannot mimic the simulator as it does not know sk.

The RO query programs as H₁(x): =h₁. However, for q=poly(κ) many queries, this x must be guessed by the reduction, which is correct with probability 1/q, incurring a loss by the same factor. Select a uniform random r←$ Zₚ, and compute gb₁=gr₁ and gbsk 1: =grsk 1. Then implicitly define ψ: =gb₁ and ye:=gbsk 1. Finally, the NIZK proof μ is simulated using the simulator KepSimu on the instance (h₁, ψ=gb₁). The simulation of ψ is executed, such that the blind state ρ for which v=H₁(x)^{ρ} remains unknown, though H₁(x) is known. This is possible because the client is honest and, therefore, ρ must come from a uniform random distribution. By setting gb=gr1=H₁(x)^{ρ}, the simulator is implicitly setting r=ρω where h₁=gω1, knowing neither w (which is basically DLOGₕ₁(gb₁)) nor ρ, but only r, which is again distributed uniformly at random. If the adversary makes an RO query H₂(π) where π=hsk 1, the reduction checks whether e(h₁, vk₂)=e(π, g₂), and if it satisfies the reduction output π as the answer to the Co-CDH challenger.

Thus, Pr[E₁]≥1/q·Pr[E₂], where the probabilities are over the random values of the reduction and the adversary and the events E₁ and E₂ are defined. E₁ is defined as the reduction breaks Co-CDH. E₂ is defined as the adversary (corrupt P_{E}) makes a RO query H₂(h^{sk}₁). The loss q was introduced due to guessing in programming the correct challenge. This concludes the proof, because q=poly(κ).

In the second case, where the client is the only corrupt party, the desired guarantee is the pseudo-randomness of the VRF output. This scenario is similar to the pseudo-randomness of the Oblivious Pseudo-random function (PRF) and is reduced similarly to the BOMDH assumption. The corrupt client may have two main objectives: (i) to produce a malformed pair (ψ, μ) and/or (ii) to distinguish y from a uniform random string. The first attached is prevented by the soundness of the NIZK proof used. However, the second scenario requires more involved handling.

In particular, it must be proved that if a corrupt client makes q=poly(κ) many complete evaluation queries to the server, it is unable to produce more than q “valid” triples (x₁,y₁, π₁), . . . , (x_{q},y_{q}, y_{q}). Unless this is true, there is a PPT reduction which would break the Bilinear One-more DH (BOMDH) problem in the underlying pairing-supported groups.

The simulator simulates the honest server by sampling a key pair (sk, vk) using Keygen and registering vk for P_{S} as vk∈Keys [P_{S}]. In this case, the adversary transmits the client's message (x, ψ, μ). The simulator transmits back ye=xesk and set β: =ye. Due to the soundness of the zero-knowledge proof, the adversary is bound to send ψ=(x, H₁(x)^{ρ}) with overwhelming probability. The adversary thus obtains π=H₁(x)^{sk} from the server interaction and then subsequently H₂(π). The hash functions H₁ and H₂ are simulated as random oracles on-the-fly in a straightforward manner. This is repeated for q=O(poly(κ)) many times, after which the adversary obtains q triples X={(xᵢ, yᵢ, i)}i∈[q].

The following probability is bounded by the probability of breaking BOMDH. Pr[E₁|E₂], where E₁ is defined as Verify (vk, (x*,y*, π*))=1∧(x*,y*, π*)∉X and E₂ is defined as P_{C} outputs (x*,y*, π*). In reducing to BOMDH, the following occurs. Given Bilinear OMDH instance g₁, g^{sk}₁, gb₁, gb₂, . . . , gbk∈1 G₁; g₂, g^{sk}₂∈G₂ for uniform generators g₁, {gbi}i∈[q], g₂ and uniform random field element sk∈Zₚ, with an exponentiation oracle, which on input any element g∈G₁ returns gsk (call this sk-exp oracle), the reduction's goal is to compute q+1 pairs (g⁻1, g^{-sk}₁), . . . , (g⁻q+1, g^{-sk}_{q+1}) by making at most q (k≥q+1) queries to the sk-exp oracle such that for all i∈[q+1], g⁻i∈7 {gb1, . . . , gbm}.

The reduction simulates the setting to the adversary (i.e., the corrupt P_{C}) as follows. When the secret-key is implicitly sk, then the verification key becomes vk: =(vk₁, vk₂), where vk₁=g^{sk}₁ and vk₂=g^{sk}₂. Each RO query H(xᵢ) is answered with gbi, and xi are stored in a list L. When the client sends (xᵢ,ψᵢ, μᵢ), the proof is verified using KExpVer. On successful verification, the sk-exp oracle is used to obtain yei: =ψisk and transmit that back to the adversary. A counter cnt keeps track of the number of distinct accesses to sk-exp oracle. Each RO query H₂(α) is answered with Rand(α). Each RO query is checked for existing xi∈L, such that e(H₁(xᵢ), vk₂)=e(α, g₂). If the check is successful, then the triple (xᵢ,yᵢ, πᵢ) is stored in a list F, where yi:=Rand(α) and πi: =α. When |F|>cnt, output F is the answer to the BOMDH challenger.

Despite the fact that the reduction, unlike the simulator, does not have access to the secret-key sk, the above simulation is correct. However, this is also resolved using the sk-exp oracle. The random oracles are simulated by plugging in the values from the challenge. As the counter is incremented whenever the adversary is able to produce one more valid triple, |F|>|cnt| and the reduction wins the BOMDH game. Thus, Pr[E]≥Pr[E₁|E₂] where E defines the event when the reduction wins the BOMDH game.

In the third case, where the server is the only corrupt party, since sk is leaked, the only guarantee would be that the output y is still computed correctly (e.g., that it is “unbiased”). When the server is corrupt, the “unpredictability aspect” of the construction is not available. However, even in that case, the public verifiability guarantees that the server cannot produce an output that is incorrect. For example, an output that is biased towards a specific value. In other words, though unpredictability cannot be guaranteed, the so-called “unbiasability” would continue to hold.

In this case, the simulator receives the verification key vk from the adversarial server P_{S} and registers it with the ideal functionality within Keys[P_{S}] while controlling the ideal server P_{S}. The simulator then simulates the honest client to the corrupt server in the following manner. First, the simulator maintains two lists/and L. I contains pairs (x,ψ), that is, the information with respect to the input and corresponding client's message (generated by the simulator). L contains tuples (x, π, β, y), that is, information from the entire evaluation, including server's message and the output with respect to an input.

Upon receiving (Input, vk, x), sample a uniform random ρ←_{$}Zₚ and then construct (x, xe) just like an honest party, where xe=(ψ: =H₁(x)^{ρ}, μ). Then, (x,ψ) is appended to a list I. When receiving a message ye from the server, if there is an (x,ψ)∈I such that e(y, g₂)=e(ψ, vk2) and if (x, *, *, *) ∉L, then issue an evaluation query (Eval, x, vk) to the ideal functionality. When the ideal functionality returns the same query, the simulator replies with (π: =ye^{1/ρ}, β: =ye). Finally, on receiving an output y from the ideal functionality store (x, π, β,γ) into L.

If there is (x, π, β, γ)∈L, then the simulator replies to the evaluation query with (π, β). Otherwise, on receiving the evaluation query from the ideal functionality, the simulator replies with ⊥. On receiving an RO query H₂(π), if there is an (x,ψ)∈I, such that e=(π, g₂)=e(H₁(x), vk₂) but (x, *, *, *)∉L, then make a (Eval, vk, x) query to the ideal functionality and respond with (π, β: =πφ. On completing the evaluation query, the simulator receives y from the ideal functionality, which it programs as an answer H₂ (π): =y. (x, π, β, y) is appended into L. If there exists a tuple (x, π, β, y)∈L, then the simulator answers with H₂ (π): =y. (c) Otherwise, the simulator responds with Rand (π).

Other queries are straightforward and the above simulation is correct with overwhelming probability. In particular, unless the adversarial server can guess H₁(x)^{sk} before observing x, the simulation would be substantially perfect. Once the server obtains x, a pair (x,ψ) gets incorporated or listed in I. There are two cases. First, where the adversary makes a RO query H₂(π), with a valid x for which the verification equation holds before it returns ye. In this case, the simulator first executes Step 4a. Then when it receives ye, the simulator executes Step 3(a) ii. The simulator is able to consistently program the random oracle and then subsequently finish the evaluation using ideal functionality.

Second, where the adversary first sends ye and later makes a RO query H₂ (π). The simulator now first executes Step 3(a) i, and then Step 4c. Since the pre-verification must be satisfied, the simulation would be substantially perfect. In case the pre-verification is not satisfied, the simulator would not allow completion of the evaluation, which it ensures by sending ⊥ to the ideal functionality. However, if the adversary can correctly predict the output of H₁(x), without explicitly making a RO query H₁(x), the simulation would fail. Specifically, the simulation fails because it could not have y without making an evaluation query to the ideal functionality. This generally only happens with negligible probability.

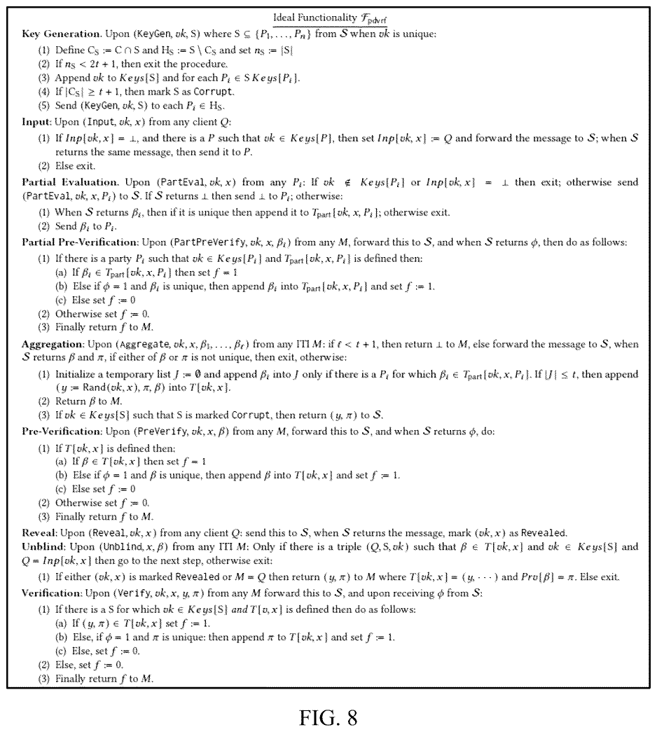

FIG. 8 illustrates exemplary functionality of a private, distributed VRF (Pri-DVRF). All guarantees are captured by the illustrated ideal functionality F_{pdvrf}. The ideal functionality interacts with parties, denoted generally by P or Q and a simulator S. Sometimes, to emphasize the distributed aspect, servers are denoted as Pᵢ. A set of n servers P₁, P₂ . . . , Pn is denoted by S, which plays a similar role to that of a single server in F_{pvrf}. Sometimes, to distinguish, a client is denoted by Q. The phrase “any ITI”, denoted by M, refers to either a party or the simulator. The ideal functionality keeps track of the following variables, all of which are initialized to ⊥ (or Ø) implicitly.

Keys [M],Keys [S]: contains the public verification keys owned by any entityM or a set of servers S={P₁, . . . , Pₙ}. Note that, if vk∈Keys [S] then vk∈Keys [Pᵢ] for each Pᵢ∈S. Note that a verification key vk is unique if there exists a unique set of servers S, for which vk∈Keys [S]—this is extended from Fpvrf, which considers uniqueness corresponding to parties.

T [vk, x]: contains entries of the form (y, (π, β), (π′, β′), . . . ) corresponding to a verification key vk and an input x exactly like in the case for Pri-VRF. The uniqueness is also defined exactly in the same manner.

Tₚₐᵣₜ [vk, x, Pᵢ]: extends the above definition to the partial setting, where each partial list corresponds to a server Pᵢ. A list Tpart contains entries β, β′, . . . , which is slightly different from lists T. Uniqueness of β is defined naturally with respect to the triple (vk, x, Pᵢ). Note that, since vk is unique to a set of servers S, it is not necessary to specify the set of servers.

Inp [vk, x]: denotes the party (client) who sent the pair (vk, x) for evaluation. This contains exactly one element, unless marked 1 (while undefined) by default.

Consider the following set of algorithms, among them, the algorithms excusive to the distributed setting are underlined:
Keygen (1^{κ}, n. t)→(vₖ, sk₁, . . . , skₙ): The key-generation algorithm (implemented by a DKG protocol) outputs a verification key vk and n shares sk1 . . . , skn of the secret-key sk where the sharing is t out of n threshold
Blind (1^{κ}, x)→(st, \ddot{x}): This algorithm processes an input x to offer a secret state st and a public output \ddot{x}
InpVer(1^{κ}, (x, \ddot{x}))=: 1/0. The input verification algorithm verifies whether the pair (x, \ddot{x}) is correctly computed, and returns 1 if and only if the check succeeds
Part.Eval (vk, skᵢ, \ddot{x})→\tilde{y}ᵢ: The partial evaluation algorithm uses the partial secret-key skᵢ on the blinded input ex to produce a blinded partial output \tilde{y}ᵢ
PartPreVer(vk, (x, \tilde{y}ᵢ))=: 1/0: There is a partial pre-verification algorithm which verifies whether the computed blinded partial value \tilde{y}ᵢ is correct for the input x and verification key vk
Aggregate (vk, {(\tilde{y}ᵢ)}i∈S)=: \tilde{y}. The aggregation algorithm gathers a set of blinded values to produce an aggregated blinded value \tilde{y}
Pre Ver (vk, (x, x, \tilde{y}))=: 1/0: There is a pre-verification algorithm, similar to PVRF, which verifies whether the computed blinded value \tilde{y} is correct for the pair (x, \ddot{x}) and verification key vk
Unblind (\tilde{y}, st)=: (y, π): The deterministic unblinding algorithm takes a blinded output \tilde{y} and a secret-state st (typically generated during the blinding procedure) then outputs an output-proof pair (y, π)
Verify (vk, (x,y, π))=: 1/0: The verification algorithm takes the public verification key vk and a pair (x,y) as input and outputs a decision bit

In the real-world, parties are connected by pairwise authenticated channels. A set of n parties P₁, P₂, . . . , Pₙ successfully run a distributed key-generation protocol that securely implements Keygen, making the verification key vk public and providing each Pᵢ with a secret-key share skᵢ. This set of parties is denoted by S: ={P₁, . . . , Pₙ}. At any point, a client Q with an input x may run Blind to generate x and subsequently send over (x,\ddot{x}) for evaluation to the servers in S (with verification key vk). Server Pᵢ in set S first runs the input-verification InpVer on (x,\ddot{x}), and if that succeeds, runs Part.Eval on (x, \ddot{x}) with (vk, skᵢ) to generate a blinded partial output \tilde{y}ᵢ, which it sends back. The values (\tilde{y}ᵢ₁, \tilde{y}ᵢ₂, . . . ) are supposed to be collected by an aggregator A (which may or may not be the same as Q or any Pᵢ), who then runs PartPre Ver on each \tilde{y}ᵢ with respect to (vk, x), and if there are at least t correct values, then it may produce a blinded output ey (otherwise it outputs 1). The client, when obtaining \tilde{y}, may first run PreVer to check whether the aggregation was done correctly (in particular when A≠Q), and if that succeeds, it may unblind using Unblind to obtain (y, π). The triple (x,y, π) can be publicly verified at any point by anyone to confirm that y was correctly produced. Furthermore, combining this with Inp Ver, PartPre Ver, and PreVer anyone can verify whether this value is computed via a particular interaction defined by the entire transcript (x, \ddot{x}, {\tilde{y}ᵢ}) i, \tilde{y},y, π).

Let Π be a protocol that operates as described above and provides the algorithm specifications. Then, Π UC-realizes the ideal functionality F_{pvrf} if for any static, malicious PPT adversary A in the real world, there exists a PPT simulator S in the ideal world, such that for all environment E:

$${Real}_{\prod , A , E} \approx {c}^{Ideal} {F}_{pvrf} , S , E$$

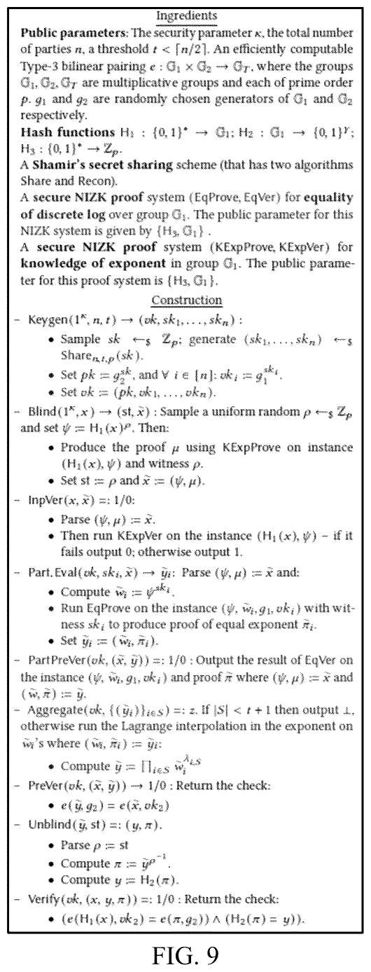

FIG. 9 illustrates an exemplary Pri-DVRF construction according to embodiments of the present disclosure. The Pri-DVRF construction is similar to the centralized Pri-VRF construction, except that the partial evaluation now generates a zero-knowledge proof of correct partial computation, which is authenticated or verified by the partial pre-verification algorithm. Changes from the centralized construction are reflected in FIG. 9. The Pri-DVRF satisfies the Pri-VRF definition as captured by the ideal functionality F_{pvrf}.

The construction presented in FIG. 9 proves the following theorem: utilizing UC-realizes F_{pvrf} with overwhelming probability, provided that the one-more BDH assumption (BOMDH) and the Co-CDH assumption hold over the underlying bilinear groups, the hash functions are modeled as random oracles, and the underlying NIZK proof systems are secure (that, in turn, require XDH).

Similar to the construction of FIG. 7, a simple setting consists of a single client P_{C} who has inputs and n servers S={P₁, . . . , Pₙ}, each of whom holds a partial VRF secret-key. That is, Pᵢ holds skᵢ after a successful DKG execution and the servers perform the evaluations jointly. The setting also includes an aggregator P_{A} who observes all communications and performs any verifications, just like the eavesdropper in FIG. 7. However, the aggregator additionally aggregates the partial responses, and sends the aggregated value to the client. The setting additionally includes an eavesdropper P_{E}. Neither of the eavesdropper's functionality is a subset of the aggregator's functionality and hence the aggregator and the eavesdropper can often be considered as a single entity. Again, for each execution corresponding to a specific (vk, x), a party plays exactly one role, although across different executions that can change.

This specific setting is without loss of generality because, with a specific (vk, x), the overall objectives of different entities can be described as follows for the above setting. The honest P_{C} and an uncorrupted set S (that has no more than t corrupt servers) intend to compute a VRF y=Vsk (x) correctly and securely, so that no one else can recover or predict y, given the entire transcripts that include x, without querying explicitly on x (which is prevented as (vk, x) is unique to each party.

If the client is corrupt, and colludes with up to t malicious servers in S, then the client tries to break the pseudo-randomness of y. In this case, the protocol should guarantee that unless the client derives y explicitly by interacting with honest servers, the value y remains pseudorandom. If only the client is honest, and all others in the system are corrupt, then the client's objective would be to ensure that the value y is, nevertheless, computed correctly by the server (and forwarded by the aggregator). The adversarial server would try to produce an incorrect (and potentially biased) value y′≠Vsk (x) such that it appears legitimate to the client. The unpredictability of y is nearly impossible to guarantee in this case.

This exhausts the objectives of all parties in the system. In more complex systems, for each execution (defined by (vk, x)), the strategy may be to assign roles to each party, and then deal with each party separately by different simulation strategies corresponding to each case respectively.

In the first case, S_{E}: P_{A}, P_{E} and a set C⊂S of servers are corrupt such that |C|≤t, where t is the threshold of the system. The client and other servers in H=S\C are honest. The first case is analogous to the first case of FIG. 7, because since less than t servers are corrupted, the secret-key sk is hidden information theoretically and hence the adversary should not see the output before the Reveal phase even if it is provided with (vk, x) and the entire transcripts. This specifically captures the “output-privacy” property introduced herein.

The simulation strategy can be extended from the centralized PVRF analysis, except for the following two things. First, in contrast to the centralized case, here the blinded output is transmitted by a potentially corrupt aggregator. However, this is rather easy to simulate due to the pre-verification check. In particular, once the simulator receives an aggregated value from the corrupt aggregator, it uses pre-verification to determine the correctness of that, and if the check fails, return 1 to the request (Aggregate, vk, x, . . . ).

Second, since there are ƒ≤t corrupt servers, the simulator must provide them the key shares {skᵢ}i∈[ƒ] (for simplicity denote the corrupt servers by P₁, . . . , P_{ƒ}). The simulator provides the key shares by computing each share using Shamir's secret sharing. Furthermore, the corrupt server's response can be checked using partial pre-verification. The adversary obtains the following values in total before the Reveal phase:

$$public key vk = ( pk = {g}^{{sk}_{2}} , \{ pki = 1 {g}^{{ski}_{1}} \} f < i \leq n ) ;$$

$$corrupt secret - keys \{ {sk}_{i} \} i ∈ [ f ]$$

$$input x , and subsequently {H}_{1} ( x ) through RO query ;$$

$$blinded input ψ = {{H}_{1} ( x )}^{ρ} and the NIZK proof of knowledge of exponent μ ;$$

$$blinded partial outputs yei = ( wei = ψ {sk}_{i} , π ei ) for i ∈ \{ f + 1 , … , n \} , where π ei is a NIZK$$

$$proof of equal exponent with respect to vki ;$$

$$blinded output ye = {{H}_{1} ( x )}^{ρ sk} .$$

Again, it is necessary to ensure that the probability that the adversary can ask an RO query to H₂(·) on π=H₁(sk) is negligible. This, again, reduces to Co-CDH similar to the centralized case. Specifically, given a Co-CDH instance g₁, g^{sk}₁, h₁∈G₁; g₂, g^{sk}₂∈G₂ for uniform random generators g₁, h₁, g₂ and a uniform random field element sk∈Zₚ, the reduction's goal is to compute h^{sk}₁. For that, the reduction simulates in the following manner. Let sk implicitly be the secret-key of the scheme and pk=g^{sk}₂. Let the corrupt set be {P₁, . . . , P_{ƒ}}. Then select t random skᵢ←_{$} Zₚ and set for each i∈[t]: vki: =g^{ski}₁. For ∈{t+1, . . . , n} use the Lagrange interpolation in the exponent to construct vki: =g^{ski}₁ where implicitly using sk at point 0 and for each i∈[t]: ski as the i-th polynomial output. vk: =(pk, {vki}i∈[n]) is set as the verification key. The RO query programs as H₁(x): =h₁. Further, select uniform random r←$ Zp, and compute gb₁=gr₁ and gb^{sk}₁: =g^{sk}₁, where ψ: =gb. Then for i∈[n] define for each i∈[n] wei: =gb^{ski}₁. The associated NIZK proof πei is simulated using EqSimu if ski is unknown, otherwise, it is computed correctly.

Finally, NIZK proof μ is simulated using the simulator KepSimu on the instance (h₁,ψ=gb₁). Similar to the centralized case, the above simulation is correct. Since no partial evaluation H₁(x)^{ski} is given to the adversary, the issue in simulating the honest partial evaluations on the challenge input does not arise.

The second case is also analogous to the second case described in FIG. 7, as ≤t corrupt servers essentially implies the secret-key is unknown to the adversary. Therefore, although the output is revealed immediately through an explicit query (no output privacy is guaranteed), the pseudo-randomness of the output should still hold. In particular, unless the client explicitly queries on x, it does not know y=Vsk (x). The simulation strategy, in this case, can be adapted from the centralized case.

In this case, the simulator simulates the honest server to a corrupt client and corrupt servers in C. Again, there are two main objectives of the adversary: (i) to produce a malformed pair (ψ, μ) and (ii) to distinguish y from a uniform random string, while controlling up to t servers. The first attack is prevented easily by the soundness of NIZK used. In handling the second attack, techniques to provide proofs of pseudo-randomness of a Distributed OPRF construction are utilized. Specifically, it must be proved that if a corrupt client makes q=poly (K) complete evaluation queries to the honest servers (here it means for each xi it completes at least t+1−ƒ honest partial evaluation queries, and the aggregation query subsequently), it is unable to produce more than q “valid” triples (x₁,y₁, π₁), . . . , (x_{q},y_{q},y_{q}). Unless this is true, there is a PPT reduction that would break the Threshold Bilinear One-more DH (T-BOMDH) problem in the underlying pairing-based groups. The following probability is bounded by the probability of breaking BOMDH. Pr[E₁|E₂] where the events are defined as follows. E₁ is defined as Verify (vk, (x*,y*, π*))=1∧(x*,y*, π*)∉X where X lists all q triples that are generated after making q “complete evaluation” queries. E₂ is defined as PC outputs a new triple (x*,y*, π*).

The reduction to BOMDH works as follows. Given a T-BOMDH instance g₁, g^{sk}₁, gb₁, gb₂, . . . , gbk∈1 G₁; g₂, g^{sk}₂∈G₂ for uniform generators g₁, {gbi}i∈[q], g₂ and uniform random field element sk∈Zₚ, and an oracle that, on query (j, g) for any element g∈G₁ and any index j∈[n] returns gD (j) where D is a t-degree polynomial such that D (0)=sk, when any ƒ≤t points are fixed by the adversary (call this the D-poly-exp oracle). In this case, since |C|={P₁, . . . , P_{ƒ}}, the reduction chooses ƒ uniform random sk j and set D (j): =sk j. The reduction's goal is to compute q+1 pairs (g⁻1, g^{-sk}₁), . . . , (g⁻q+1, g^{-sk}_{q+1}) by making at most q (k≥q+1) “complete queries” to the D-poly-exp oracle, such that for all i∈[q+1], g⁻i∈{gb1, . . . , gbm}, each complete query means at least querying for ≥t′: =t+1-ƒ distinct j.

The reduction simulations the setting to the adversary as follows. Let sk implicitly be the secret-key of the scheme and pk=g^{sk}₂. For the corrupt set C={P₁, . . . , P_{ƒ}} select ƒ random sk j←_{$} Zₚ. For each j∈[ƒ]: vk j: =g sk j 1. For j∈{ƒ+1, . . . , t}, use the D-poly-exp oracle to get vk j: =g1D (j), where implicitly using D (0)=sk and for each j∈[ƒ]: D (j)=sk j. For g₁, the oracle was queries only t′−1 times, and it will not be counted towards the budget. Set vk: =(pk, {vk j}j∈[n]) as the verification key.

Each RO query H (xi) is answered with gbi. Each xi are stored in a list L. When the corrupt client sends (xi,ψi, μi, Pj), first verify the proof using KExpVer. If verification is successful, then use the D-poly-exp oracles to obtain wej: =ψisk j for honest Pj and return that to the adversary. A counter cnt[xi] keeps track of the number of distinct access to D-poly-exp oracle. Another counter cnt tracks the total number of completed query. The NIZK proof of equality of exponent is simulated and each RO query H₂(α) is answered with Rand(α). Each such query is checked against existing xi∈L such that e(H₁(xᵢ), vk₂)=e(α, g₂). If true, the triple (xᵢ,yᵢ, πᵢ) is recorded to a list F, where yi: =Rand(α) and πi: =α. At any time |F|>cnt, the output F as the answer to the T-BOMDH challenger.

The above simulation is correct despite the fact that the reduction, unlike the simulator, does not have access to the secret-key sk. However, this was resolved using the D-poly-exp oracle. The random oracles are simulated by plugging in the values from the challenge. As the counter cnt is incremented only when an evaluation query is completed, that is whenever the adversary has acquired sufficient information to produce one more valid triple, |F|>|cnt| and the reduction wins the BOMDH game. Thus, Pr[E]≥Pr[E₁|E₂] where E defines the event when the reduction wins the BOMDH game.

The third case is also analogous to the second case of FIG. 7. In this case, the “unpredictability aspect” of the construction is unavailable. However, even in this case the “public verifiability” guarantees that the server cannot produce an output that is incorrect. That is, the server cannot produce an output biased towards a specific value. In other words, though unpredictability cannot be guaranteed, the so-called “unbiasability” would continue to hold. The simulator, in this case, receives the verification key vk from the adversary and registers it with the ideal functionality within Keys[S] while controlling the servers.

The simulator then simulates the honest client to the servers in C as follows. First, the simulator maintains two lists/and L, where I contains pairs (x,ψ), that is the information with respect to the input and corresponding client's message (generated by the simulator); and L contains tuples (x, π, β,y), that is information from the entire evaluation, including server's message and the output with respect to an input. Upon receiving (Input, vk, x), the simulator samples a uniform random ρ←$ Zₚ and then constructs (x, xe) just like an honest party, where xe=(ψ: =H₁(x)^{ρ}, μ). (x,ψ) is appended to a list I. On receiving a message ye from the aggregator P_{A}, there are two options. One, if there is an (x,ψ)∈I such that e(y, g e 2)=e(ψ, vk2) and if (x, *, *, *)∉L, then issue an evaluation query (Eval, x, vk) to the ideal functionality. When the ideal functionality returns the same query, reply with (π: =yel/ρ, β: =ye). Finally, on receiving an output y from the ideal functionality store (x, π, β,y) into L. (ii) If there is (x, π, B,y)∈L: reply to the evaluation query with (π, β). Second, on receiving the evaluation query from the ideal functionality, reply with ⊥. On receiving an RO query H₂(π), if there is an (x,ψ)∈I, such that e=(π, g₂)=e (H₁(x), vk₂) but (x, *, *, *)∉L, then make a (Eval, vk, x) query to the ideal functionality and respond with (π, β: =πp). On the completion of the evaluation query, receive y from the ideal functionality which it programs as an answer H₂(π): =y. (x, π, β,y) is appended or incorporated into L. If there exists a tuple (x, π, β,y)∈L, then answer with H₂(π): =y. Otherwise just respond with Rand(π).

Other queries are straightforward to handle in this case. The above simulation is correct with overwhelming probability. In particular, unless the adversarial server can guess H₁(x)^{sk} before observing x, the simulation would be perfect. Once the server obtains x, a pair (x,ψ) gets listed in I. Then there are two cases. First, the adversary makes a RO query H₂(π), with a valid π for which the verification equation holds, before it returns ye: in this case, the simulator first executes Step 4a. Later when it receives ye, it executes Step 3(a) ii. In this case, the simulator is able to consistently program the random oracle and then subsequently finish the evaluation using ideal functionality.

Second, the adversary first sends ye and later makes a RO query H₂(π). The simulator now executes Step 3(a) i, and later Step 4c. In this case, since the pre-verification must be satisfied, the simulation would be perfect. Of course, in case the pre-verification does not satisfy, the simulator would not allow to complete the evaluation, which it ensures by sending ⊥ to the ideal functionality. However, if the adversary can correctly predict the output of H₁(x) without explicitly making RO query H₁(x), the simulation would fail, as it could not have y without making an evaluation query to the ideal functionality—this happens only with negligible probability.

The NIZK proof extends naturally from the centralized case. However, each time, up to t malicious servers need to be dealt with. However, since they do not possess the secret-key, this case essentially becomes analogous to the scenario in the centralized setting when the server is honest. For example, when the client is honest and there is at most t server corruption, output privacy must be guaranteed. To argue that, this is now reduced to a threshold variant of the BOMDH problem, called Threshold-Bilinear One-more Diffie-Hellman (T-BOMDH). Analyses of the other cases are similar to the centralized setting.

In some embodiments, the NIZK proof of equality computed in the partial evaluation may be omitted if each g^{ski}₂ were publicly available, and PartPreVer was performed using bilinear pairing e (\ddot{x}, g^{ski}₂)=e (\tilde{y}, g₂). However, this would incur concrete computation overhead because verifying a NIZK proof of equality amounts to four (4) exponentiations in the group G₁, which is about 2.5× more efficient than a single bilinear pairing verification. Adding output-privacy to that construction is relatively straightforward. Moreover, the issue of strong vs weak pseudorandomness for the DVRF constructions does not appear for the respective Pri-DVRF constructions. It has been shown that Dfinity-DVRF cannot be proven strongly pseudorandom, which allows an adversary to make honest partial evaluation queries on the challenge input. Weaker notions were referred to as pseudo-randomness and do not allow those queries. It has also been shown that GLOW-DVRF can actually be proven to satisfy the stronger notion. In the corresponding Pri-DVRF construction, this does not seem to be the case, as the present approach relies on T-BOMDH oracles for simulating partial evaluation queries.

### Performance Analysis

Table 1 below compares the Pri-DVRF construction of the present disclosure with the GLOW-DVRF construction.

TABLE 1

| | Input-Generation | Partial-Eval. | |
|---|---|---|---|
| GLOW-DVRF (MCL) | — | 253.304 | μsec |
| Pri-VRF (MCL) | 307.09 μsec | 403.059 | μsec |
| GLOW-DVRF (Relic) | — | 1.30304 | msec |
| Pri-VRF (Relic) | 1.67658 msec | 2.5978 | msec |

The framework of the present disclosure supports mcl [1] and RELIC [5] cryptographic libraries. For a given input, the requester generates a random blinding value and a NIZK proof of the correctness of the blinded input. The proof is a Schnorr signature-based proof of knowledge of the DLog exponent. It consists of two elements, one scalar and one group G1 element. After receiving the blinded input, each VRF node verifies the zero-knowledge proof before computing the partial evaluation of the VRF. The requester receives the aggregated evaluation and unblinds the output private VRF using the pre-computed blinding value to obtain the final VRF output. Benchmarks of the different steps of the VRF computation uses mcl[1] and RELIC libraries[5] for the BN256 curve. The single-threaded implementation runs on Mac OSX 2015 with an intel i7-3.1 GHz processor with 16 GB RAM. With the MCL library, the requester takes approximately 307μ see on an average for computing H(x)r (for the input x and the blinding factor r) and the zero-knowledge proof of exponent r. Each VRF node verifies the zero-knowledge proof (ZKP) and then computes the H(x)r·ski for the secret share skᵢ. The partial evaluation, including verifying the ZKP per node, takes approximately 403 μsec. Unblinding by the requester involves one exponentiation and takes on an average approximately 146 μsec.

The GLOW-DVRF, which is non-private, does not involve any input blinding, and the input message x is forwarded to the VRF nodes. Each VRF node computes the partial evaluation H (x) skᵢ, which takes approximately 253μ see per node on average. The computation times for the steps of input-blinding at the requester and the partial evaluation at the VRF node are presented in Table 1; the table provides the timings for the operations using both the mcl and the RELIC libraries. The reported values are taken as a mean over 100 iterations over each operation. It is estimated that the gas cost for the VRF verification on the BN256 curve would be approximately 250k gwei.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the methods and embodiments described herein. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc, laser disc, optical disc, digital versatile disc, floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present subject matter. Various modifications to these embodiments will be readily apparent to those skilled in the art, and the generic principles defined herein may be applied to other embodiments without departing from the spirit or scope of the subject matter. Thus, the present subject matter is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting.

What is claimed:

1. A method of generating a blinded random output, comprising:
executing a randomness request by a requester;
sharing fractions of a key with a committee to generate partial evaluations of a random output, the partial evaluations being blinded;
aggregating the partial evaluations of the random output, the partial evaluations of the random output also being blinded;
generating a blinded public output corresponding to the randomness request; and
sending the blinded public output to the requester, such that the requester may obtain the blinded random output.

2. The method of claim 1, wherein executing a randomness request by a requester comprises:
receiving a blinded input corresponding to the randomness request;
generating an input tag; and
sending the input tag to a verifiable random function service.

3. The method of claim 2, wherein receiving the blinded input corresponding to the randomness request comprises:
receiving an input;
creating a tagged input based on the received input;
sending the tagged input to the requester; and
receiving the blinded input and a proof of correctness for the blinded input.

4. The method of claim 2, wherein generating an input tag comprises including a component of an identity of the requester.

5. The method of claim 1, wherein executing a randomness request by a requester is executed by a smart contract.

6. The method of claim 1, wherein the blinded public output is published on a blockchain via a smart contract without publishing the random output.

7. The method of claim 1, wherein only the requester can obtain the blinded random output.

8. The method of claim 1, further comprising publicly verifying the blinded public output to ensure legitimacy of the blinded random output without making the blinded random output public.

9. The method of claim 1, wherein aggregating the partial evaluations of the random output comprises:
receiving one or more partial evaluations verified through a proof and a secret-key fraction;
eliminating incorrect partial evaluations; and
combining one or more verified partial evaluations.

10. The method of claim 9, wherein generating a blinded public output corresponding to the randomness request comprises combining the one or more partial evaluations and combining one or more proofs for equality of exponent to compute a value in a bilinear pairing.

11. A method of generating a private random output comprising:
executing a randomness request by a requester for a future randomness need;
sharing a key with a committee to generate partial evaluations of a random output;
aggregating the partial evaluations of the random output;
generating a private public output corresponding to the randomness request;
verifying the private public output; and
sending the verified private public output to the requester, such that the requester may obtain the private random output for the future randomness need.

12. The method of claim 11, wherein aggregating the partial evaluations of the random output, generating a private public output corresponding to the randomness request, and verifying the private public output occur publicly.

13. The method of claim 11, wherein executing a randomness request by a requester for a future randomness need comprises:
receiving an input by a user;
sending the input back to the user for blinding to generate a private input;
receiving the private input and a proof of correctness of the private input; and
sending the private input and the proof of correctness to the committee.

14. The method of claim 13, further comprising verifying the proof of correctness of the private input and computing partial evaluations of the random output.

15. The method of claim 11, wherein the future randomness need is asynchronous to generation and verification of the private public output.

16. A method of asynchronously obtaining a blinded random output comprising:
sending a blinded randomness request for a random output;
receiving a blinded public output corresponding to the random output;
privately obtaining the random output; and
generating one or more pseudorandom outputs from the privately obtained random output, the one or more pseudorandom outputs to be used immediately or for a future random need.

17. The method of claim 16, wherein sending a blinded randomness request for a random output comprises:
sending an input to a server;
receiving a created input from the server;
blinding the created input to generate a blinded input; and
sending the blinded input and a proof of correctness to the server.

18. The method of claim 16, wherein receiving a blinded public output corresponding to the random output comprises:
receiving a blinded value of a bilinear pairing; and
unblinding the blinded value, wherein the unblinded value is used to privately obtain the random output.

19. The method of claim 16, wherein the one or more pseudorandom outputs are used for a future random need asynchronously from sending the blinded randomness request for a random output.

20. The method of claim 16, where the blinded randomness request for a random output is publicly verifiable for legitimacy without publishing the random output.
